(19) United States
(12) Patent Application Publication
(10) Pub. No.: US 2012/0296621 A1
(43) Pub. Date: Nov. 22, 2012

(54) DEVICE AND METHOD FOR PREDICTION OF ACUTE HEART FAILURE MORTALITY

(75) Inventors: Douglas S. Lee, Toronto (CA); Jack V. Tu, Toronto (CA)

(73) Assignees: UNIVERSITY HEALTH NETWORK, Toronto (CA); SUNNYBROOK RESEARCH INSTITUTE, Toronto (CA)

(21) Appl. No.: 13/472,944

(22) Filed: May 16, 2012

Related U.S. Application Data
(60) Provisional application No. 61/488,474, filed on May 20, 2011.

(51) Int. Cl. G06G 7/48

(52) U.S. Cl. 703/11

(57) ABSTRACT

Various embodiments are described herein for a device and a method that can be used to determine a Heart Failure (HF) risk score for an individual with a risk of acute heart failure. The technique comprises employing a HF risk model that uses demographic, transportation, vital signs, blood test, medication and pre-existing co-morbid information to determine the HF risk score for the individual.

### CROSS-REFERENCE

This application claims priority to U.S. Provisional Application No. 61/488,474, filed May 20, 2011, and the entire contents are hereby incorporated by reference.

### FIELD

Various embodiments are described herein relating to a device and method for providing a heart failure risk score.

### BACKGROUND

Heart failure is a major public health issue that is characterized by high lethality and increased rates of hospital admissions and readmissions. Patients with decompensated heart failure frequently visit emergency departments and experience high rates of hospital readmission, which result in increased health care costs. In fact, heart failure contributes to over 1 million emergency department visits per year in North America. Despite the substantial resource and economic implications of hospitalization of patients with heart failure, the decision to admit or discharge patients is often not guided by evidence. As a consequence, clinicians discharge heart failure patients from the emergency department based on symptomatic improvement, without considering the acute prognosis of the patient, because it is difficult to properly select and assimilate the required subset of information from all of the information that is collected from the patient in order to properly diagnose the patient.

Reliance on clinical judgement for the acute heart failure patient, rather than an outcomes-based approach may have undesired effects, including excess hospital admission of low-risk patients. Conversely, patients with heart failure who seem to improve and are discharged may die after leaving the emergency department. In fact, there is substantial overlap in the prognostic profiles of heart failure patients, using conventional assessment techniques, who present to the emergency department who are subsequently discharged or admitted to hospital.

Prior prognostic studies have focused on hospitalized heart failure patients, and have often excluded those who were discharged from the emergency department. However, those who are discharged from the emergency department comprise a large proportion of all heart failure patients and they are also at significant risk of acute mortality.

### SUMMARY

Embodiments described herein generally relate to a method and device for acute mortality determination in individuals who are at risk of heart failure and present themselves to a medical institution. The determination of acute mortality can be used to decide on what kind of treatment the individuals require including whether the individuals require admission to a hospital or other medical facility or whether they can be safely discharged.

In one aspect, at least one embodiment described herein provides a method of determining a Heart Failure (HF) risk score for an individual with a risk of acute heart failure. The method comprises receiving demographic information; receiving transportation information; receiving vital signs information; receiving blood test information; receiving pre-existing co-morbid information; receiving medication information; and determining the HF risk score by employing a risk score model that employs the received information as values for corresponding variables in the risk score model.

In an embodiment, the demographic information comprises an age of the individual.

In an embodiment, the transportation information comprises an indication of whether an emergency medical services (EMS) vehicle delivered the individual to a medical facility for evaluation.

In an embodiment, the vital signs information comprises systolic blood pressure (SBP), heart rate, and oxygen saturation level (O₂ sat) for the individual.

In an embodiment, the blood test information comprises troponin detectability, creatinine level and potassium level for the individual.

In an embodiment, the pre-existing co-morbid information comprises an indication of whether the individual has cancer.

In an embodiment, the medication information comprises an indication of whether the individual is currently prescribed metolazone.

In an embodiment, based on the received information for the individual, the HF risk score can be determined by multiplying age in years by 2 to form a first term; multiplying SBP in mmHg by −1 to form a second term with a lower bound of −160 mmHg for SBP greater than 160 mmHg; setting HR in beats/min to a third term with a lower bound of 80 if HR is less than 80 bpm and an upper bound of 120 if HR is greater than 120; multiplying O₂ sat in % by −2 to form a fourth term and limiting the fourth term to −2*92 for O₂ sat greater than 92%; multiplying creatinine in mg/dL by 20 to form a fifth term; setting a sixth term to 60 if the individual was transported by an EMS vehicle or otherwise setting the sixth term to 0; setting a seventh term to 30 if potassium concentration is greater than or equal to 4.6 mmol/L or setting the seventh term to 5 if potassium concentration is less than or equal to 3.9 mmol/L or setting the seventh term to 0 if potassium concentration is between 4 and 4.5 mmol/L; setting an eighth term to 60 if troponin is greater than the ULN or otherwise setting the eighth term to 0; setting a ninth term to 45 if an indication of cancer is present or otherwise setting the ninth term to 0; setting a tenth term to 60 if the individual is currently prescribed metolazone; and adding the first to tenth terms. It should be understood that the coefficients, values and limits described in this paragraph can be varied up to a small percentage, such as up to ±10% for example, such that the variation does not significantly affect the HF risk score.

In an embodiment, determining the HF risk score can further comprise adding an adjustment factor equal to about 12 to the first to tenth terms so that positive risk scores are associated with a greater risk of HF.

In an embodiment, the method can further comprise determining a probability of 7 day mortality for the individual by comparing the HF risk score with a distribution of HF risk scores, or according to exp(Y)/(1+exp(Y)), where Y is a log odds score of 7 day mortality.

In an embodiment, the method further comprises determining Y based on the received information for the individual by multiplying age in years by 0.0335293833 to form a first term; multiplying SBP in mmHg by −0.020998711 to form a second term with an upper bound of SBP of 160 mmHg for SBP measurements greater than 160 mmHg; multiplying HR in beats/min by 0.0143214613 to form a third term with lower and upper bounds of 80 bpm and 120 bpm for the individual's HR if their HR measurement is outside of that range; multiplying O₂ sat in % by −0.029957152 to form a fourth term and limiting the fourth term to −0.029957152*92 for O₂ sat greater than 92%; multiplying creatinine in mg/dL by 0.299500172 if measured in mg/dL or by 0.003388011 if measured in μmol/L to form a fifth term; setting a sixth term to 1.0443208989 if the individual was transported by an EMS vehicle or otherwise setting the sixth term to 0; setting a seventh term to 0.5345942581 if potassium concentration is greater than or equal to 4.6 mmol/L or setting the seventh term to +0.0891085889 if potassium concentration is less than or equal to 3.9 mmol/L or setting the seventh term to 0 if potassium concentration is between 4 and 4.5 mmol/L; setting an eighth term to 1.0129186121 if troponin is greater than ULN or otherwise setting the eighth term to 0; setting a ninth term to 0.7443598966 if an indication of cancer is present or otherwise setting the ninth term to 0; setting a tenth term to 0.9764137093 if the individual is currently prescribed metolazone; and adding the first to tenth terms. It should be understood that the coefficients, values and limits described in this paragraph can be varied up to a small percentage, such as up to ±10% for example, such that the variation does not significantly affect the HF risk score.

In an embodiment, an adjustment factor of about −3.976117131 is added to the sum of the first to tenth terms.

In an embodiment, the method can further comprise applying the HF risk score to individuals admitted at an emergency department of a hospital and storing the calculated risk scores to build a database to determine a threshold for the HF risk score to delineate between individuals at high risk and low risk of HF.

In another aspect, at least one embodiment described herein provides a computer readable medium having instructions stored thereon that are operable when executed by a processor for performing a method of determining a Heart Failure (HF) risk score for an individual with a risk of acute heart failure wherein the method comprises: receiving demographic information; receiving transportation information; receiving vital signs information; receiving blood test information; receiving pre-existing co-morbid information; receiving medication information; and determining the HF risk score by employing a risk score model that employs the received information as values for corresponding variables in the risk score model.

The computer readable medium also have instructions for performing the method of determining HF risk score according to the various method steps described herein.

In another aspect, at least one embodiment described herein provides an electronic device for determining a Heart Failure (HF) risk score for an individual with a risk of acute heart failure. The electronic device comprises at least one interface configured to receive and transmit information about the individual; and a processor configured to control the operation of the electronic device and communicate with the at least one interface. The processor is configured to receive age information, transportation information, vital signs information; blood test information; pre-existing co-morbid information, and medication information for the individual. The processor is further configured to determine the HF risk score by employing a risk score model that employs the received information as values for corresponding variables in the risk score model.

In an embodiment, the demographic information comprises an age of the individual, the transportation information comprises an indication of whether an EMS vehicle delivered the individual to a medical facility for evaluation, the vital signs information comprises systolic blood pressure (SBP), heart rate (HR) and oxygen saturation level (O₂ sat) for the individual, the blood test information comprises troponin detectability, creatinine level and potassium level for the individual, the pre-existing co-morbid information comprises an indication of whether the individual has cancer, and the medication information comprises an indication of whether the individual is currently prescribed metolazone.

In an embodiment, based on the received information for the individual, the processor is configured to determine the HF risk score by: multiplying age in years by 2 to form a first term; multiplying SBP in mmHg by −1 to form a second term with a an upper bound of 160 mmHg for SBP; setting HR in beats/min to a third term with a lower bound of 80 if HR is less than 80 bpm and an upper bound of 120 if HR is greater than 120; multiplying O₂ sat in % by −2 to form a fourth term and limiting the fourth term to −2*92 for O₂ sat greater than 92%; multiplying creatinine in mg/dL by 20 to form a fifth term; setting a sixth term to 60 if the individual was transported by an EMS vehicle or otherwise setting the sixth term to 0; setting a seventh term to 30 if potassium concentration is greater than or equal to 4.6 mmol/L or setting the seventh term to 5 if potassium concentration is less than or equal to 3.9 mmol/L or setting the seventh term to 0 if potassium concentration is between 4 and 4.5 mmol/L; setting an eighth term to 60 if troponin is greater than ULN or otherwise setting the eighth term to 0; setting a ninth term to 45 if an indication of cancer is present or otherwise setting the ninth term to 0; setting a tenth term to 60 if the individual is currently prescribed metolazone; and adding the first to tenth terms. It should be understood that the coefficients, values and limits described in this paragraph can be varied up to a small percentage, such as up to ±10% for example, such that the variation does not significantly affect the HF risk score.

In an embodiment, the processor is further configured to add an adjustment factor equal to about 12 to the first to tenth terms so that positive risk scores are associated with a greater risk of HF.

In an embodiment, the processor is further configured to determine a probability of HF for the individual by comparing the HF risk score with a distribution of HF risk scores.

In an embodiment, the processor is further configured to determine a probability of 7 day mortality for the individual according to exp(Y)/(1+exp(Y)), where Y is a log odds score of 7 day mortality.

In an embodiment, the processor is further configured to determine Y based on the received information for the individual by multiplying age in years by 0.0335293833 to form a first term; multiplying SBP in mmHg by −0.020998711 to form a second term with an upper bound of SBP of 160 mmHg for SBP measurements greater than 160 mmHg; multiplying HR in beats/min by 0.0143214613 to form a third term with lower and upper bounds of 80 bpm and 120 bpm for the individual's HR if their HR measurement is outside of that range; multiplying O₂ sat in % by −0.029957152 to form a fourth term and limiting the fourth term to −0.029957152*92 for O₂ sat greater than 92%; multiplying creatinine in mg/dL by 0.299500172 if measured in mg/dL or by 0.003388011 if measured in μmol/L to form a fifth term; setting a sixth term to 1.0443208989 if the individual was transported by an EMS vehicle or otherwise setting the sixth term to 0; setting a seventh term to 0.5345942581 if potassium concentration is greater than or equal to 4.6 mmol/L or setting the seventh term to +0.0891085889 if potassium concentration is less than or equal to 3.9 mmol/L or setting the seventh term to 0 if potassium concentration is between 4 and 4.5 mmol/L; setting an eighth term to 1.0129186121 if troponin is greater than ULN or otherwise setting the eighth term to 0; setting a ninth term to 0.7443598966 if an indication of cancer is present or otherwise setting the ninth term to 0; setting a tenth term to 0.9764137093 if the individual is currently prescribed metolazone; and adding the first to tenth terms. It should be understood that the coefficients, values and limits described in this paragraph can be varied up to a small percentage, such as up to ±10% for example, such that the variation does not significantly affect the HF risk score.

In an embodiment, an adjustment factor of about −3.976117131 is added to the sum of the first to tenth terms.

In an embodiment, the electronic device is one of a desktop computer, a laptop, a mobile device, a smart phone, a cell phone, a tablet, a personal digital assistant, and a dedicated hardware device.

In an embodiment, the electronic device is one of a desktop computer, a laptop, a mobile device, a smart phone, a cell phone, a tablet, a personal digital assistant, a dedicated hardware device, an IT system of a medical institution, an Emergency Department Electronic Medical Records system and an Emergency Department Triage system.

In an embodiment, the electronic device is a web server that is configured to provide a webpage for determining at least one of the HF risk score and 7 day probability of mortality.

In an embodiment, the electronic device is a web server and the information required for the individual is sent to the web server in an electronic communication, the web server being configured to determine at least one of the HF risk score and the probability of 7 day mortality and then send this information to a predefined destination.

In an embodiment, the electronic device is one of an IT system of a medical institution, an Emergency Department Electronic Medical Records system and an Emergency Department Triage system.

In another aspect, at least one embodiment described herein provides a use of an HF risk score model for determining a Heart Failure (HF) risk score for an individual with a risk of acute heart failure, wherein the use comprises carrying out the various methods defined herein.

In another aspect, at least one embodiment described herein provides a use of an HF risk score model for determining whether an individual should be admitted to a hospital or discharged, wherein the use comprises carrying out the various methods defined herein.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

For a better understanding of the various embodiments described herein and to show more clearly how these various embodiments may be carried into effect, reference will now be made, by way of example only, to the accompanying drawings which show at least one example embodiment and in which:

FIG. 1 is a block diagram of an example embodiment of an electronic device that can provide a Heart Failure (HF) risk score;

FIG. 2 is an example embodiment of a method for determining a HF risk score;

FIG. 3 is an example of a HF risk model that can provide a HF risk score and a 7 day mortality probability model;

FIG. 4 is an example of a GUI interface that can be used to receive values for the variables in the HF risk model and provide a HF risk score;

FIG. 5 is a table showing baseline characteristics for derivation and validation cohorts used to derive the HF risk model;

FIG. 6 is a table showing a univariate analysis of relevant variables for use in generating the HF risk model;

FIG. 7 is a table showing a multivariate analysis of relevant variables for use in generating the HF risk model;

FIG. 8 shows tables of mortality rates and odds ratios for 7-day death stratified by discharge vs. admission status;

FIGS. 9a-9f show cubic spline curves of 7-day mortality versus age, systolic BP, Heart Rate, Creatinine, Oxygen Saturation and Potassium, respectively;

FIG. 10 shows a distribution of HF risk scores in the derivation and validation datasets; and

FIG. 11 shows absolute 7-day mortality rates according to HF risk score quantiles.

### DETAILED DESCRIPTION

Various devices or processes will be described below to provide an example of an embodiment of each claimed invention. No embodiment described below limits any claimed invention and any claimed invention may cover processes or devices that differ from those described below. The claimed inventions are not limited to devices or processes having all of the features of any one device or process described below or to features common to multiple or all of the devices or processes described below. It is possible that a device or process described below is not an embodiment of any claimed invention. Any invention disclosed in a device or process described below that is not claimed in this document may be the subject matter of another protective instrument, for example, a continuing patent application, and the applicant, inventor or owners do not intend to abandon, disclaim or dedicate to the public any such invention by its disclosure in this document.

Furthermore, it will be appreciated that numerous specific details are set forth in order to provide a thorough understanding of the various embodiments described herein. However, it will be understood by those of ordinary skill in the art that the various embodiments may be implemented without these specific details. In other instances, well-known methods, procedures and components have not been described in detail so as not to obscure the embodiments described herein. Further, where considered appropriate, reference numerals may be repeated among the figures to indicate corresponding or analogous elements.

It should be noted that terms of degree such as “substantially”, “about” and “approximately” as used herein mean a reasonable amount of deviation of the modified term such that the end result is not significantly changed. These terms of degree should be construed as including a deviation of up to ±10% of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about.” The term “about” means up to plus or minus 10% of the number to which reference is being made.

Furthermore, in the following passages, different aspects of the embodiments are defined in more detail. Each aspect so defined may be combined with any other aspect or aspects unless clearly indicated to the contrary. In particular, any feature indicated as being preferred or advantageous may be combined with at least one other feature or features indicated as being preferred or advantageous.

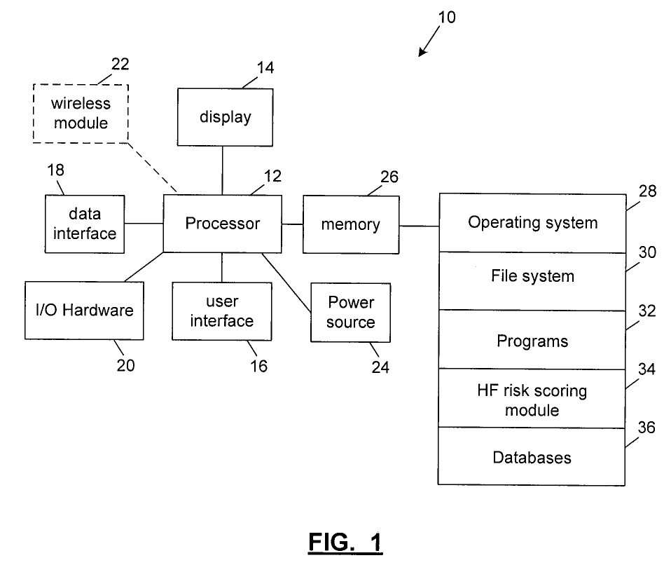

Referring now to FIG. 1, shown therein is an example embodiment of an electronic device 10 that can provide a Heart Failure (HF) risk score for an individual that arrives at a medical institution experiencing heart problems. The electronic device 10 comprises at least one processor 12, a display 14, a user interface 16, data interface 18, Input/Output (I/O) hardware 20, a wireless module 22, a power source 24 and a memory 26. The memory 26 comprises software code for implementing an operating system 28, a file system 30, various programs 32, a HF risk scoring module 34 and a database 36. The electronic device 10 can be a desktop computer, a laptop, a mobile device, a smart phone, a cell phone, a tablet, a personal digital assistant, and the like. Alternatively, the electronic device 10 can be a dedicated hardware device with associated software and firmware that is configured to provide the HF risk score as described herein.

The processor 12 controls the operation of the electronic device 10 and can be any suitable processor depending on the configuration of the electronic device as is known by those skilled in the art. The display 14 can be any suitable display that provides visual information depending on the configuration of the electronic device. For instance, the display 14 can be a cathode ray tube monitor, a flat-screen monitor and the like if the device 10 is a computer. In other cases, the display 14 can be a display suitable for a laptop, tablet or handheld device such as an LCD-based display and the like.

The user interface 16 can include at least one of a mouse, a keyboard, a touch screen, a thumbwheel, a track-pad, a track-ball, a card-reader, voice recognition software and the like again depending on the particular implementation of the electronic device 10. In some cases, some of these components can be integrated with one another.

The data interface 18 can be any interface that allows the electronic device 10 to communicate with other devices or computers. In some cases, the data interface 18 can include at least one of a serial port, a parallel port or a USB port that provides USB connectivity. The data interface 18 can also include at least one of an Internet or local area network connection through an Ethernet, Firewire or modem connection or through a digital subscriber line. Various combinations of these elements can be incorporated within the data interface 18.

The I/O hardware 20 can include at least one of a microphone, a speaker and a printer. The wireless module 22 is optional and can be a radio that communicates utilizing the CDMA, GSM, GPRS or Bluetooth protocol according to standards such as IEEE 802.11a, 802.11b, or 802.11g. The power source 24 can be any suitable power source that provides power to the electronic device 10 such as a power adaptor or a rechargeable battery pack depending on the implementation of the electronic device 10 as is known by those skilled in the art.

The memory 26 can include RAM and flash memory elements as well as other storage elements such as disk drives and hard drives. The memory 26 is used to store an operating system 28, a file system 30 and programs 32 as is commonly known by those skilled in the art. For instance, the operating system 28 and the file system 30 provide various basic operational processes for the electronic device 10. The programs 32 include various user programs so that a user can interact with the electronic device 10 including viewing and manipulating data as well as sending messages as the case may be.

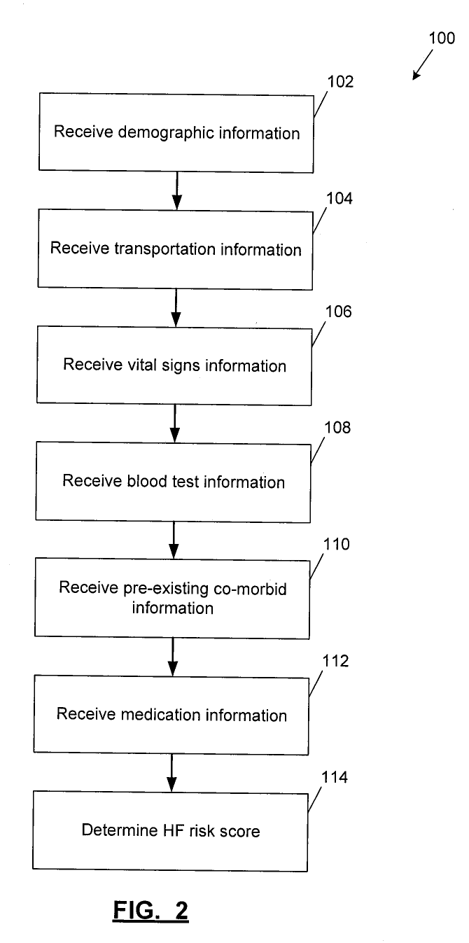

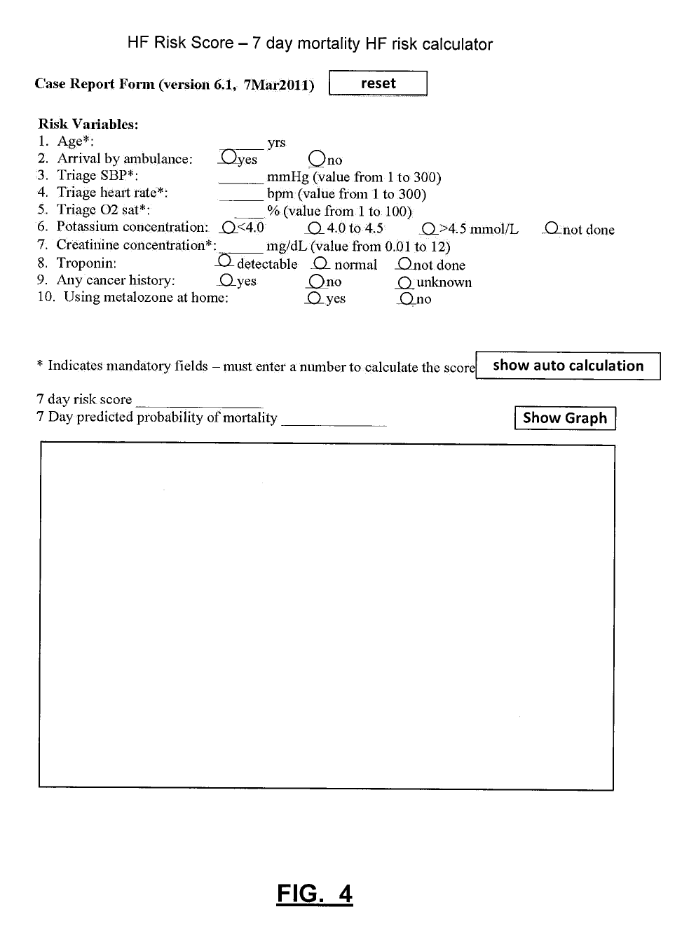

The memory 26 also stores the HF risk scoring module 34 and one or more databases 36. The HF risk scoring module 34 can determine HF risk scores for individuals based on information received for the individuals as well as a risk scoring model which is described in more detail below with respect to FIGS. 2 to 4. In some embodiments, the HF risk scoring module 34 can also be configured to provide a probability of 7 day mortality by using another model as described in detail with respect to FIG. 4. The databases 36 can be used to store data for individuals scored with the HF risk scoring module 34. The databases 36 can also store other information required for the operation of the programs 32 or the operating system 28 such as dynamically linked libraries and the like.

The electronic device 10 comprises at least one user interface and the processor 12 communicates with at least one of these user interfaces to receive medical information for the individual. This can be through the user interface 16, the data interface 18 or the wireless module 22. For instance, the medical information can be inputted by someone through the user interface 16 or it can be received through the data interface 18 from patient records. The processor 12 can communicate with either one of these interfaces as well as the display 14 or the I/O hardware 20 in order to output the HF risk score that is determined by the processor 12. For instance, the electronic device 10 can output the HF risk score to a user of the electronic device 10. In addition, users of the electronic device 10 can communicate the resulting HF risk score across a network connection to a remote system for storage and/or further analysis by other medical personnel. This communication can also include email communication.

In an alternative embodiment, the electronic device 10 can be a computer that acts as a web server and provides content for a web site. One of the webpages on the website can be a webpage that provides a HF risk score as described herein. In this case, a user can interact with the webpage to directly enter the information required for the HF risk model (described below) and the web page can display at least one of the HF risk score and 7 day probability of mortality. Alternatively, the required information for the individual can be sent to the web server in an email or electronic communication, the web server can determine at least one of the HF risk score and the probability of 7 day mortality and then send this information to a predefined destination. The user can interact with the web server and provide the required information using a desktop computer, a laptop, a tablet, a smart phone or any other suitable electronic device. The web server can be local to a medical institution, such as a hospital for example, or can be part of a centralized system that is remote from the medical institution.

In other alternative embodiments, the HF risk scoring module 34 can be incorporated into other IP applications that are provided by the medical institution. For example, the HF risk scoring module 34 can be incorporated into a hospital's IT system or in Emergency department software applications, such as, but not limited to patient flow software, an Emergency Department Electronic Medical Records system and an Emergency Department Triage system. Alternatively, the HF risk scoring module 34 can be incorporated into other medical software applications.

Referring now to FIG. 2, shown therein is an example embodiment of a method 100 of determining a HF risk score for an individual that is at risk of HF. Typically, the individual will have arrived at an emergency department of a hospital experiencing heart problems but it may be possible that this assessment can be made at other medical institutions. Information about the individual is obtained by performing medical tests and/or by referring to the medical history of the individual as well as from other people that have arrived with the individual at the medical institution. This could include EMS staff, family and friends. At step 102, demographic information is received for the individual. In an embodiment, the demographic information can comprise the individual's age. At step 104, transportation information is received which is indicative of how the individual arrived at the emergency department. In an embodiment, the transportation information can be based on whether the individual was transported via an EMS vehicle. At step 106, vital signs information is received for the individual. In an embodiment, the vital signs information can comprise the individual's Systolic Blood Pressure (SBP), Heart Rate (HR) and oxygen saturation level (O₂ sat). At step 108, blood test information is received for the individual. In an embodiment, the blood test information can comprise an indication of troponin detectability, as well as creatinine and potassium levels. At step 110, pre-existing co-morbid information is received for the individual. In an embodiment, the pre-existing co-morbid information can comprise whether the individual has cancer. At step 112, medication information is received for the individual. In an embodiment, the medication information can comprise whether the individual takes metolazone. In alternative embodiments, the medication information can also comprise diuretics in general (e.g. furosemide) and nitrates. At step 114, the HF risk score is determined for the individual based on the information that has been received and a HF risk model. The HF risk score then provides an indication of whether the individual is at a high risk of HF or a low risk of HF. The score can be used by a medical practitioner in deciding whether to admit the individual to a medical institution, such as a hospital, for further treatment or whether it is safe to send the individual home.

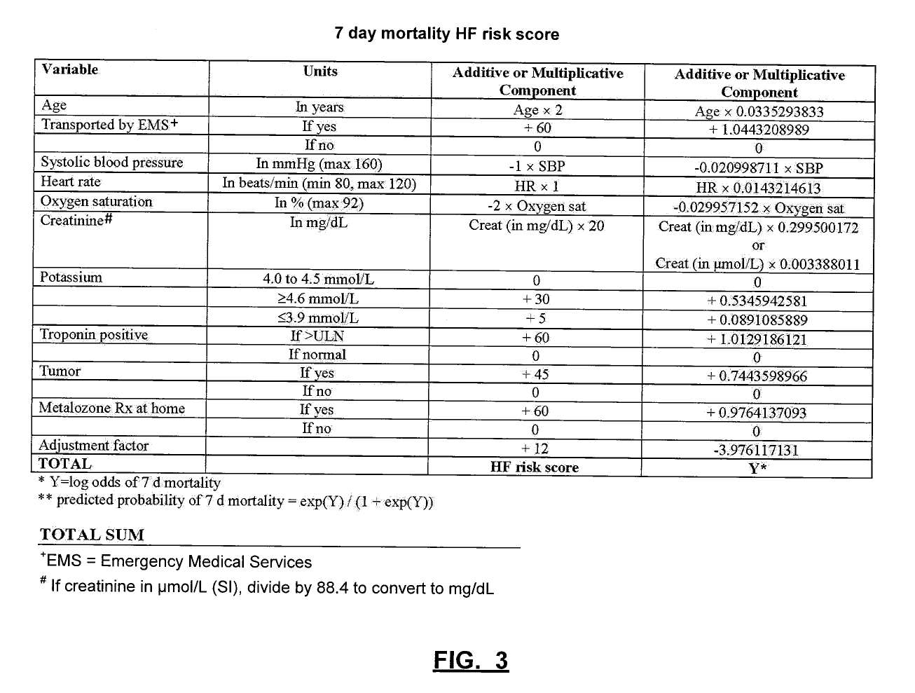

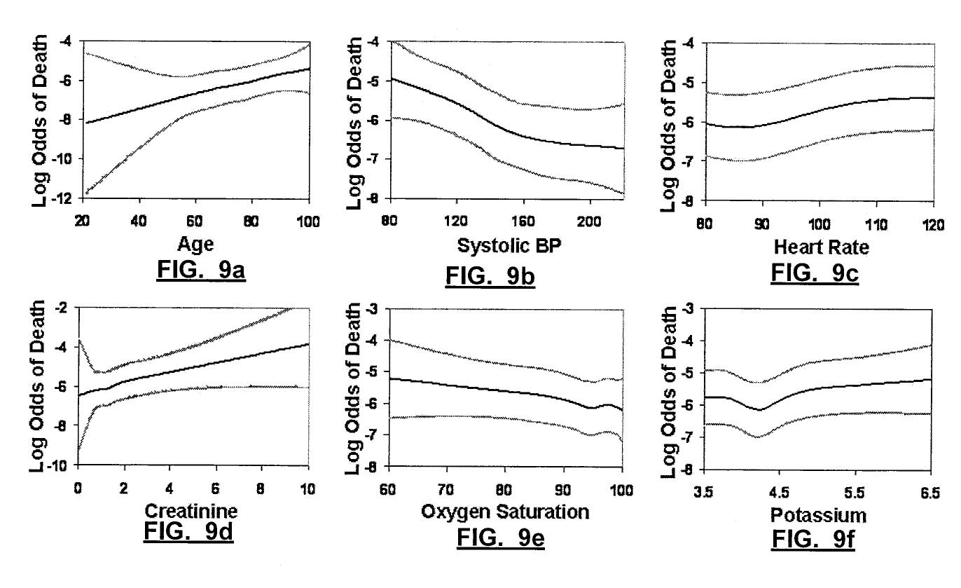

Step 114 of the method 100 comprises combining the received information according to a multivariate HF risk model, which is developed based on a database of patient information, to obtain the HF risk score. An example embodiment of the HF risk model is shown in FIG. 3 including the units in which the information is obtained as well as how the information is used in the model. For example, the variables representing the individual's age, systolic blood pressure, oxygen saturation and creatinine level are multiplicative variables whereas the variables representing the individual's potassium and troponin levels, whether the individual was transported by an Emergency Medical Services (EMS) vehicle, whether the individual has cancer and whether the individual takes (i.e. is currently prescribed) metolazone are additive. Also, an adjustment factor of 12 points is optionally added to shift the median value of the HF risk score to approximately zero such that the HF risk scores that are higher than the median and numerically positive confer an increased risk of death. Further, it should be noted that some variables have limits (related to the spline analysis of real patient data shown in FIGS. 9A-9F). For example, for SBP, any SBP value for the individual that is greater than 160 mmHg is assigned the value 160, for HR, any HR value for the individual that is less than 80 bpm is assigned the value 80 while any value that is greater than 120 is assigned the value 120, and for O₂ sat, any O₂ sat value for the individual that is greater than 92% is assigned the value 92%.

In an alternative embodiment, the electronic device 10 and the method 100 can be modified to additionally store the HF risk scores that are determined by the HF risk model in the database 36. This allows a given medical institution to determine its own statistics for individuals who present themselves with heart problems by recording the individuals' HF risk scores, whether these individuals are admitted to the medical institution or released and the 7-day mortality rate of these individuals. This can allow the medical institution to determine a threshold value for the HF risk score so that individuals who present themselves in the future to the medical institution can be properly treated in order to keep the 7-day mortality rate below a certain target or acceptable level.

Referring now to FIG. 4, shown therein is an example embodiment of a user interface that can be used to receive values for the variables used in the HF risk model. This information is typically collected once the individual is admitted to the Emergency department of a hospital. This interface can be provided by a PDF document, by a spreadsheet or a standalone executable program. Once all of the required information is input, the HF risk score is calculated and displayed. The 7 day predicted probability of mortality can optionally be displayed as well. A medical practitioner can then use the HF risk score and/or the probability of 7 day mortality as another piece of information in deciding whether to admit the individual to the hospital or whether to send the individual home.

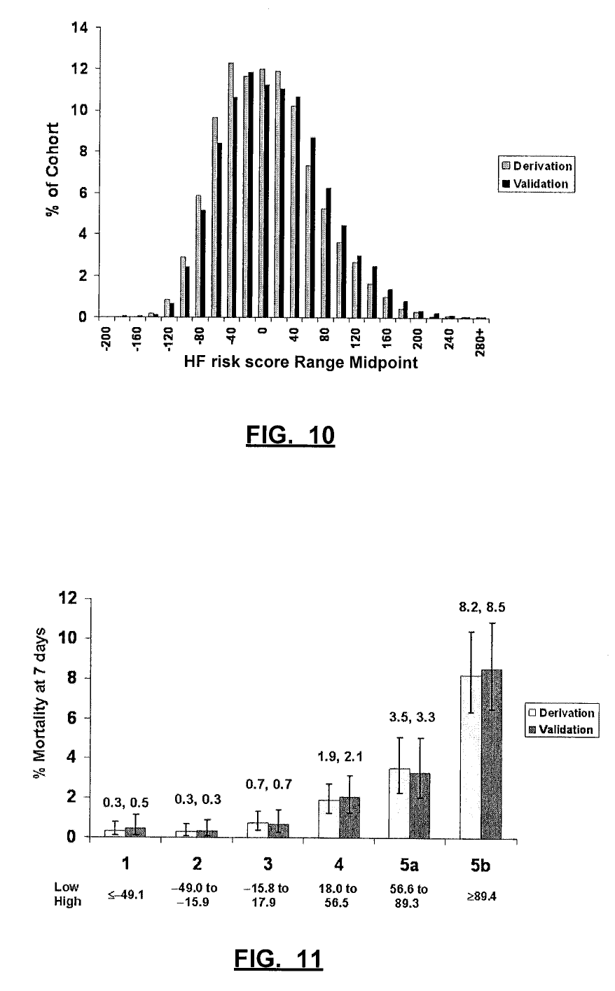

The 7 day predicted probability of mortality for the individual can be obtained by comparing the individual's HF risk score with a distribution of HF risk scores (i.e. see the histogram in FIG. 10 for example). Alternatively, the probability of death for the individual can be determined by using equation 1:

prob of 7 day mortality=exp(Y)/(1+exp(Y)) (1)

where Y is a log odds score of 7-day mortality as calculated in FIG. 3. Accordingly, the log odds score (Y) can be calculated based on the received information for the individual, by multiplying age in years by 0.0335293833 to form a first term; multiplying SBP in mmHg by −0.020998711 to form a second term with an upper bound of SBP of 160 mmHg for SBP measurements greater than 160 mmHg; multiplying HR in beats/min by 0.0143214613 to form a third term with lower and upper bounds of 80 bpm and 120 bpm for the individual's HR if their HR measurement is outside of that range; multiplying O₂ sat in % by −0.029957152 to form a fourth term and limiting the fourth term to −0.029957152*92 for O₂ sat greater than 92%; multiplying creatinine in mg/dL by 0.299500172 if measured in mg/dL or by 0.003388011 if measured in pmol/L to form a fifth term; setting a sixth term to 1.0443208989 if the individual was transported by an EMS vehicle or otherwise setting the sixth term to 0; setting a seventh term to 0.5345942581 if potassium concentration is greater than or equal to 4.6 mmol/L or setting the seventh term to +0.0891085889 if potassium concentration is less than or equal to 3.9 mmol/L or setting the seventh term to 0 if potassium concentration is between 4 and 4.5 mmol/L; setting an eighth term to 1.0129186121 if troponin is greater than Upper Limit of Normal (ULN) or otherwise setting the eighth term to 0; setting a ninth term to 0.7443598966 if an indication of cancer is present or otherwise setting the ninth term to 0; setting a tenth term to 0.9764137093 if the individual is currently prescribed metolazone; and adding the first to tenth terms. An adjustment factor of −3.976117131 is added to the sum of the first to tenth terms to shift the median value of Y value to near-zero.

It should be noted that minor changes may be made to some of the coefficients, integer scores and covariates in the models shown in FIG. 3, while still providing acceptable values for the HF risk score and the probability of 7 day mortality. For example, the coefficients, values and limits described in this paragraph can be varied by up to a small percentage, such as up to ±10% for example, such that the variation does not significantly affect the HF risk score.

Furthermore, some of these coefficients, integer scores and covariates are sensitive to the diagnostic methods or medical procedures used to obtain values for the corresponding variables. While these coefficients, integer scores and covariates correspond to diagnostic methods and medical procedures that are commonly practiced and known to those skilled in the art, changes may or may not be needed for some of the coefficients, integer scores and covariates if new diagnostic methods and medical procedures are used to obtain the information from the individual. Therefore, the models shown in FIG. 3 are generally applicable but may require some adjustments depending on the effect of changes made to how some of the individual's information is collected in the future.

In order to derive the models shown in FIG. 3, a study was conducted of approximately 12,500 patients who visited an emergency department for heart failure and were either discharged home or admitted to the hospital from Apr. 1, 2004 to Mar. 31, 2007, in Ontario, Canada, which has a provincial population of over 13 million. Stratified random sampling was used to randomly select patients for detailed chart abstraction from hospitals for those discharged from the emergency department and hospitals for those admitted to hospital. Heart failure cases were initially identified using the International Classification of Diseases 10th revision (ICD-10 code 150) from the National Ambulatory Care Reporting System for emergency department visits and the Canadian Institute of Health Information database for hospitalized patients. To be included in this study, patients were required to fulfill the Framingham criteria for heart failure at the time of emergency department presentation. Patients who were palliative or had do-not-resuscitate orders before emergency department arrival, transfers from another acute care hospital, and those who were dialysis dependent were excluded from the study.

In order to assess the performance of the model to predict HF risk in an independent patient cohort, the overall sample was randomly split into derivation and validation datasets. The model was derived on a random sample of approximately 7,500 heart failure patients, of whom 2/3 were hospitalized and 1/3 were discharged from the emergency department, reflecting the 2:1 ratio of admission to discharge from which the study population was sampled. The validation cohort was comprised of approximately 5,000 patients with a similar ratio of hospitalized vs. discharged patients. Prior to gathering the data, research ethics approval was obtained from Sunnybrook Health Sciences Centre and also from hospitals where chart abstraction was performed.

The charts of patients who presented to the emergency department were abstracted by highly-trained nurse abstractors to obtain clinical information pertaining to the patient (e.g., comorbidities, pre-hospital medications) and presenting features (e.g., mode of presentation, vital signs) using methods as described in Tu et al., “Effectiveness of public report cards for improving the quality of cardiac care: the EFFECT study: a randomized trial”, JAMA 2009, 302(21), pp. 2330-2337. Nurse abstractors were required to demonstrate high reliability on standardized chart abstractions prior to field deployment. A random sample of patients' charts (n=543) were re-abstracted to determine reliability, and those variables with kappa statistic >0.7 and/or crude agreement >85% were further examined in a statistical analysis. Using the patients' unique, encrypted health card number, these data were linked to the Registered Persons Vital Status Database for determination of death within 7 days of emergency department presentation.

Continuous variables were reported as mean±standard deviation and compared using Student's t-test or Kruskal-Wallis test for non-parametric distributions, while categorical variables were compared using the X² statistic. Potential predictors of death within 7 days of emergency department presentation in the derivation set were examined using univariate logistic regression. Mortality predictors with p<0.25 were entered into a multiple logistic regression model, using stepwise selection, and variables with p<0.05 were retained in the final model. For continuous variables, the strength and shape of the relationship of potential predictors of death were examined using cubic spline analyses, and based on these analyses, upper and lower bounds were determined for the purposes of identifying truncation values above or below which there was no further contribution to the score calculation. An age standardized p-coefficient method (Sullivan LM, et al., “Presentation of multivariate data for clinical use: The Framingham Study risk score functions.” Stat Med. 2004; 23: pp. 1631-1660; Steyerberg E W. “Clinical prediction models: a practical approach to development, validation, and updating series.” New York: Springer; 2009; Harrell F E Jr, et al. “Multivariable prognostic models: issues in developing models, evaluating assumptions and adequacy, and measuring and reducing errors.” Stat Med. 1996; 15: pp. 361-387), as is known by those skilled in the art, was used to develop the HF risk score model by summing integer scores for categorical variables and multiplicative scores for continuous variables.

Model discrimination in both the derivation and validation datasets was evaluated using the c-statistic. In the derivation sample, both the apparent area under the receiver operating characteristic (ROC) curve, referred to as the c-statistic, and optimism-corrected areas under the ROC curve were estimated. Optimism-corrected measures were obtained using 200 bootstrap samples drawn with replacement from the derivation sample. Calibration was assessed in multiple ways including the Hosmer-Lemeshow X² statistic, the calibration slope, and calibration-in-the-large (Steyerberg, Clinical Prediction Models, New York, Springer Science, 2009). No over-fit was confirmed using linear shrinkage estimators (y>0.85) (Harrell, et al. “Multivariable prognostic models: issues in developing models, evaluating assumptions and adequacy, and measuring and reducing errors”, Stat Med 1996; 15(4): 361-387). Model performance was also assessed using the Brier score (Harrell, Regression modeling strategies, New York, Springer-Verlag, 2001). All analyses were performed using SAS version 9.2 (Cary, N.C.) for UNIX.

A total of 15,164 patients who visited the emergency department and met the Framingham criteria for heart failure were examined, of whom 10,781 were admitted to hospital and 4,383 were discharged without admission. Patients were excluded because they were palliative (n=2,246), were dialysis-dependent (n=312), or were transferred from an acute care hospital (n=15). There were 12,591 patients included in this study, of whom 7,433 constituted the derivation cohort, comprised of 5,254 admitted and 2,179 discharged from the emergency department. The independent validation cohort was comprised of 5,158 patients of whom 3,560 were admitted and 1,598 were discharged.

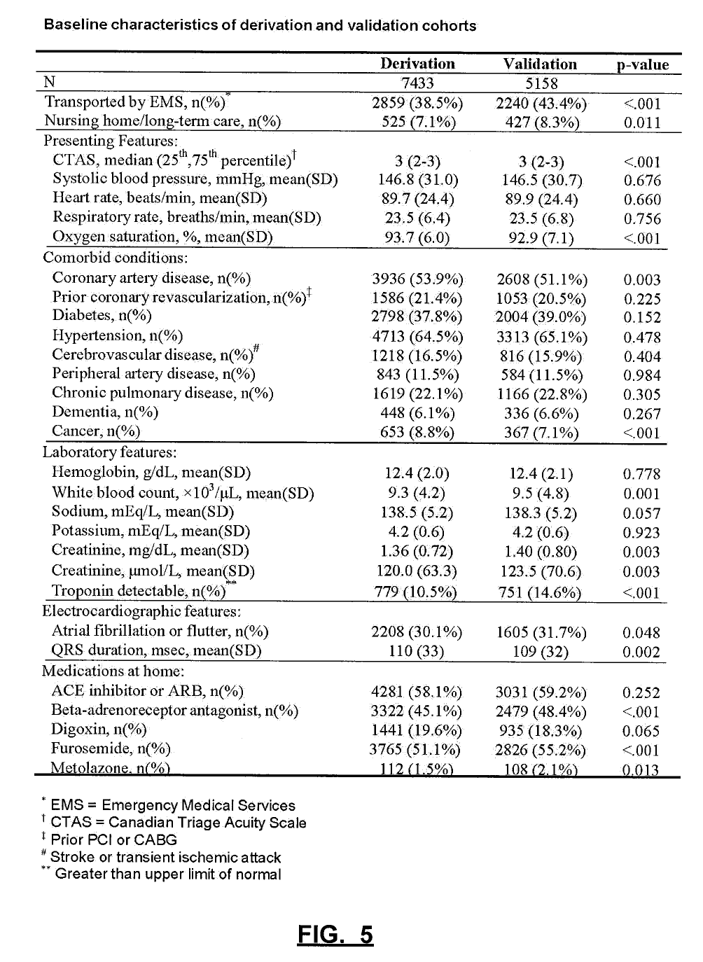

The average age of the derivation cohort was 75.4±11.4 years and 3,825 (51.5%) were men, while the average age of the validation cohort was 75.7±11.4 years with 2,661 men (51.6%). There were 247 deaths overall, with a 7-day mortality rate of 2.0%. Mortality at 7 days was 1.8% in the derivation (135 deaths) and 2.2% in the validation (112 deaths) cohorts. While baseline characteristics of the two cohorts were comparable, the validation cohort was comprised of more patients transported by emergency medical services, with more diuretic use and troponin elevation, and marginally higher creatinine. The baseline characteristics of the derivation and validation cohorts are shown in FIG. 5.

Univariate predictors of 7-day death are shown in FIG. 6. Patient characteristics that were associated with increased mortality in the derivation cohort included older age, resident of nursing home or long-term care facility, lower systolic blood pressure, and lower oxygen saturation. Mortality tended to increase with higher heart rate. Among the comorbidities, cerebrovascular disease, dementia, and cancer increased mortality risk. A non-normal troponin was associated with increased risk of death, as were other laboratory features including lower hemoglobin concentration, and higher white blood count, potassium, and creatinine. Patients who were transported by emergency medical services were nearly 4-fold more likely to die compared to those presenting without paramedic assistance. Those who presented with acute heart failure despite taking furosemide or metolazone at home were also at higher risk of 7-day death.

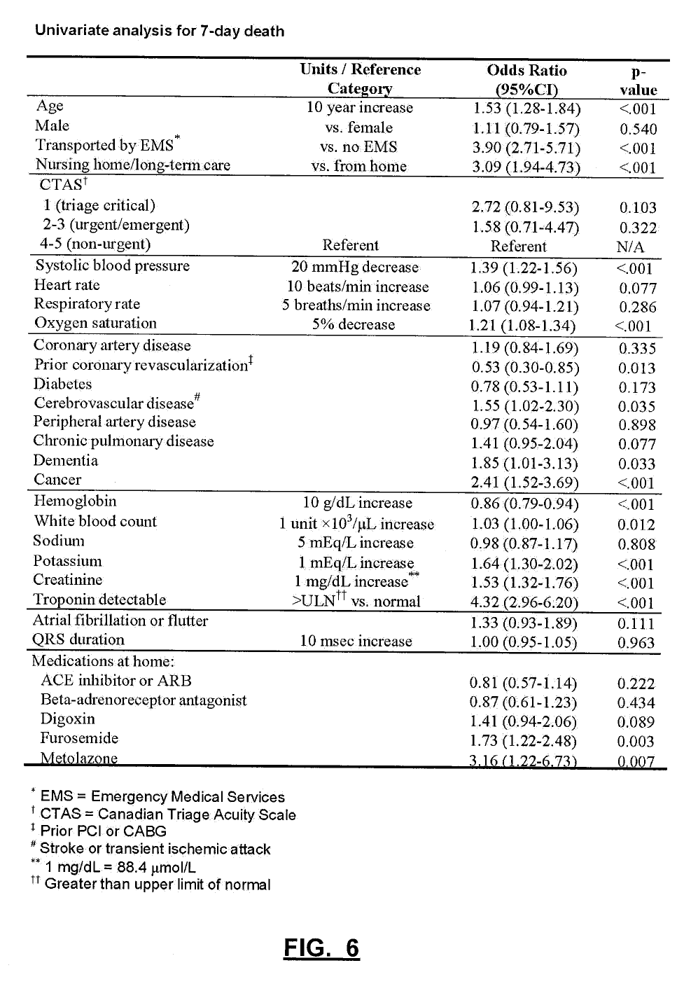

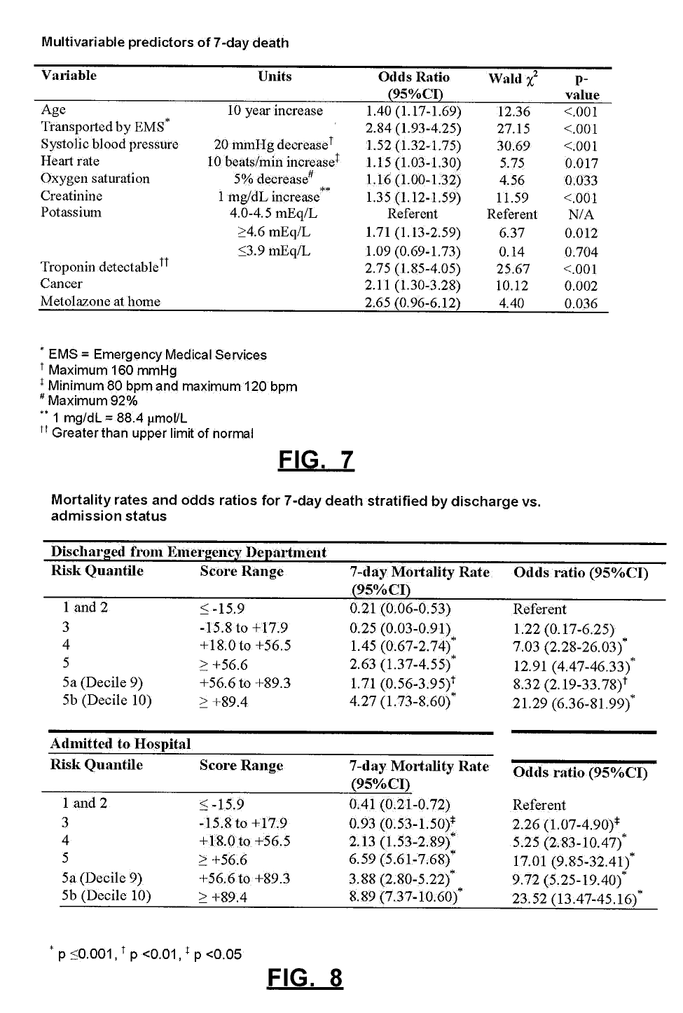

Multi-variable predictors of 7-day death are shown in FIG. 7. Cubic regression splines adjusted for multivariable model covariates are shown in FIGS. 9a-9f. The relationships of age and creatinine concentration with the log odds of 7-day mortality were linear throughout the range of values. Systolic blood pressure and oxygen saturation were inversely related to the log odds of death, with an attenuated slope at higher values. Potassium concentration displayed a U-shaped relationship with mortality. While furosemide use was associated with mortality in univariate analysis, it did not seem to be statistically significant when metolazone use was included in the multivariable model.

In the derivation data set, the c-statistic of the multivariable model was 0.805, suggesting high discrimination. The bootstrap-corrected unbiased estimate of the receiver operating characteristic curve area was 0.811 (95% Confidence Interval (CI); 0.770-0.847). There was no lack of model fit with a Hosmer-Lemeshow X² statistic of 4.31 (p=0.828), and no overfit as determined by a heuristic linear shrinkage estimator (γ=0.946).

In the external validation dataset, the c-statistic of the multivariable model was 0.826, with no lack of model fit (Hosmer-Lemeshow X² statistic was 2.99, p=0.935). In the validation dataset, the calibration slope was 0.970 (95% CI; 0.810-1.131) and the calibration-in-the-large p-value was 0.923, denoting no miss-calibration. The generalized R² was 0.150. The Brier score was 0.20.

As shown in FIG. 10, the HF risk score was normally distributed (kurtosis=0.180, skewness=0.505) with a mean of 5.9±62.0 and a median of 0.5 (25th, 75th percentiles: −40.2, 44.6). For each 20 point increase in the HF risk score, the risk of 7-day death increased by 41% (odds ratio 1.41, 95% CI; 1.34-1.48) in the derivation cohort, and by 39% (odds ratio 1.39, 95% CI; 1.32-1.47) in the validation cohort (both p<0.001). For each 1-standard deviation (SD) increase in the HF risk score, the 7-day mortality risk increased by 2.9-fold with an odds ratio of 2.88 (95% CI; 2.47-3.37) in the derivation and 2.92 (95% CI; 2.45-3.50) in the validation cohorts, respectively (both p<0.001). The c-statistic of the HF risk score was 0.807 in the derivation set and 0.806 (95% CI; 0.761-0.842) after bootstrap correction. The c-statistic of the HF risk score was 0.803 in the validation set and 0.804 (95% CI; 0.763-0.840) after bootstrap correction.

FIG. 11 shows mortality rates according to risk score quintiles with the highest 2 deciles of risk being shown at the right of FIG. 11. Mortality rates in the derivation cohort ranged from 0.3% (lowest risk score≦−49.1, quintile 1) to 8.2% (highest risk, quintile 5-decile 10). Quintile 2 (−49.0≦score≦15.9) also had a low 7-day mortality rate of 0.3%. Mortality was higher in quintile 3 (−15.8≦score≦+17.9) and quintile 4 (+18.0≦score≦+56.5) with the latter approximating the overall 7-day mortality rate. Quintile 5 (score≧+56.6) contained the two highest risk deciles with mortality rates of 3.5% (decile 9 or risk group 5a, +56.6≦score≦+89.3) and 8.2% (decile 10 or risk group 5b, score≧+89.4). Compared to the lowest risk quintile, the odds ratios for death was 18.4 (95% CI; 8.3-52.5) in quintile 5, 10.8 (95% CI; 4.5-31.9) in decile 9 (i.e. group 5a), and 26.5 (95% CI; 11.7-76.1) in decile 10 (i.e. group 5b) (all p<0.001). The results were comparable when the same HF risk score thresholds were applied to the validation dataset (FIG. 11).

The HF risk score stratified mortality risk among those who were discharged from the emergency department and those who were admitted to hospital. The 7-day mortality rate in the 2 lowest risk quantiles was 0.2% among those discharged from the emergency department, with greater than a 12-fold risk in quantile 5 and a 21-fold risk in the highest risk group (5b) corresponding to decile 10 (both p<0.001), in the validation and derivation cohorts combined (see FIG. 8, upper panel). Among those who were admitted to hospital, mortality in the 2 lowest risk quantiles was 0.4%, with a 17-fold risk in quantile 5 and a 23-fold risk (both p<0.001) in the highest risk group (5b) corresponding to decile 10 (see FIG. 8, lower panel).

Heart failure patients who seek care in the emergency department, including those who are ultimately admitted or discharged, are often managed based on symptoms because prognostic tools for the broad group of patients with heart failure have not been available, and the acute benefits of the indiscriminately-hospitalized are unclear. However, the electronic device 10 and the method 100 employ a prediction model that can be used for patients with acute heart failure in the emergency department. Unlike prior studies which examined only those who were hospitalized, the HF risk model was developed in a study cohort whose entry point was presentation to the emergency department with heart failure, and included those who were ultimately discharged home or admitted to hospital. Accordingly, the HF risk score can be used to predict the risk of death in the next 7 days after emergency department presentation, which can be used to guide decision-making acutely. Mortality risks in the highest two deciles were more than 10-fold (9th decile) and 25-fold (10th decile) higher than the lowest risk quintile. Compared to the average 7-day mortality rate of 2% overall, the mortality rate in the two lowest risk quintiles was 0.3%. The HF risk model performed well in an independent external validation dataset, was well calibrated, and performed better than inpatient scores applied to emergency department patients.

A major distinction between this study and prior studies of heart failure risk is that this study examined all patients presenting to the emergency department, irrespective of whether they were admitted to hospital or discharged home. If a model is intended to guide admission-discharge decisions based on acute prognosis, it is important to examine a sample of patients whose inception is presentation to the emergency department, and not only hospitalized patients. The examination of a broad cohort of emergency department patients with heart failure was likely a major contributor to the superior discrimination of the HF risk model. Furthermore, heart failure guidelines provide general considerations when deciding upon admission or discharge of heart failure patients in the emergency department. However, these guideline recommendations are based on consensus opinion and potentially disparate studies of isolated predictors, rather than multivariable models of acute heart failure prognosis.

Many variables included in the HF risk model reflect biological perturbations that predispose one to increased mortality risk. Among acutely ill heart failure patients, worsened oxygen status reflects greater respiratory compromise and severity of pulmonary congestion. Lack of elevation of systolic blood pressure in the patient with acute heart failure has been widely identified as a mortality predictor, reflecting underlying left ventricular contractile dysfunction. Higher heart rates may reflect multiple contributing processes including the need for increased chronotropy to maintain cardiac output and greater sympatho-adrenergic response. The findings in this study show the acute prognostic impact of the cardiorenal axis with inclusion of both creatinine and metolazone in the model. While furosemide use was significant in univariate analysis, its effect waned when creatinine and metolazone were included in the model. In prior studies, lack of response to metolazone indicated an especially poor prognosis, which may be partly related to diuretic resistance. The mechanism for the biphasic effect of potassium (increased risk at low and high values) is complex, and may reflect disturbances of the renin-angiotensin-aldosterone system, effects of medications, or alterations in renal function. Additionally, troponin elevation could have contributed to mortality risk via myocyte necrosis as a consequence of acute heart failure or as a causally contributing factor resulting from myocardial ischemia, resulting in a downstream destabilizing impact. The data in this study showed that those who required paramedic transport were also at substantially higher risk of death and that the occurrence of acute heart failure, despite the use of metolazone, was a more potent factor associated with early death in the multivariable analysis. The above factors are available in real-time at virtually all emergency departments, and thus the HF risk model described herein has broad applicability.

The HF risk model has several implications for heart failure care. As a decision-support method specifically developed for use in patients who present to the emergency department, this instrument has immediate potential application. Those with high early mortality risk may require more rapid diagnostic and therapeutic intervention and hospital admission. In contrast, those at low risk could potentially be discharged from the emergency department and be offered appropriate follow-up care. The HF risk score may also provide guidance on the intensity of post-discharge follow-up of those discharged from the emergency department. Specifically, intermediate risk patients who are discharged may require early and more intensive follow-up care and additional collaborative input from cardiac specialists, with whom improved outcomes have been demonstrated. Finally, the HF risk score may be useful to reduce heart failure readmissions, since some repeat emergency visits are low-risk patients who may not need re-hospitalization.

The HF risk model is a clinical risk model that can predict acute mortality within 7 days for heart failure patients who present to the emergency department with high accuracy using only readily-available factors including history, physical signs, and routine laboratory tests. The importance of this risk model for prognostication is underscored by the inclusion of patients who present to the emergency department irrespective of disposition and prediction of death within 7 days of presentation. Acute heart failure outcomes may be improved if greater intensity and more rapid care are provided to patients who are higher mortality risk. However, while the HF risk score is predictive prognostically, it does not replace clinical judgement. As with all clinical prediction rules, decisions regarding hospital admission or discharge and the intensity of care should be guided by the HF risk score combined with clinical judgement, and not solely based on a numerical result.

The embodiments described herein generally include processor-implemented methods and devices for practicing those methods in the form of computer program code containing instructions embodied in tangible computer media (i.e. CD-ROM, etc.) or any other computer-readable storage medium, wherein, when the computer program code is loaded into and executed by the processor 12, the processor 12 becomes a device for determining a HF risk score for individuals at risk of acute heart failure.

The various embodiments described herein have been provided as examples only. It should be understood that various modifications can be made to the embodiments described and illustrated herein, without departing from these embodiments, the scope of which is defined in the appended claims. For example, there can be alternative embodiments in which the model does not use some of the variables or uses more variables.

1. A method of determining a Heart Failure (HF) risk score for an individual with a risk of acute heart failure, wherein the method comprises:
receiving demographic information;
receiving transportation information;
receiving vital signs information;
receiving blood test information;
receiving pre-existing co-morbid information;
receiving medication information; and
determining the HF risk score by employing a risk score model that employs the received information as values for corresponding variables in the risk score model.

2. The method of claim 1, wherein the demographic information comprises an age of the individual.

3. The method of claim 1, wherein the transportation information comprises an indication of whether an emergency medical services (EMS) vehicle delivered the individual to a medical facility for evaluation.

4. The method of claim 1, wherein the vital signs information comprises systolic blood pressure (SBP), heart rate (HR) and oxygen saturation level (O₂ sat) for the individual.

5. The method of claim 1, wherein the blood test information comprises troponin detectability, creatinine level and potassium level for the individual.

6. The method of claim 1, wherein the pre-existing co-morbid information comprises an indication of whether the individual has cancer.

7. The method of claim 1, wherein the medication information comprises an indication of whether the individual is currently prescribed metolazone.

8. The method of claim 1, wherein, based on the received information for the individual, the method comprises determining the HF risk score by:
multiplying age in years by 2 to form a first term;
multiplying SBP in mmHg by −1 to form a second term with a an upper bound of 160 mmHg for SBP;
setting HR in beats/min to a third term with a lower bound of 80 if HR is less than 80 bpm and an upper bound of 120 if HR is greater than 120;
multiplying O₂ sat in % by −2 to form a fourth term and limiting the fourth term to −2*92 for O₂ sat greater than 92%;
multiplying creatinine in mg/dL by 20 to form a fifth term;
setting a sixth term to 60 if the individual was transported by an EMS vehicle or otherwise setting the sixth term to 0;
setting a seventh term to 30 if potassium concentration is greater than or equal to 4.6 mmol/L or setting the seventh term to 5 if potassium concentration is less than or equal to 3.9 mmol/L or setting the seventh term to 0 if potassium concentration is between 4 and 4.5 mmol/L;
setting an eighth term to 60 if troponin is greater than ULN or otherwise setting the eighth term to 0;
setting a ninth term to 45 if an indication of cancer is present or otherwise setting the ninth term to 0;
setting a tenth term to 60 if the individual is currently prescribed metolazone; and
adding the first to tenth terms,
wherein coefficients, values and limits recited herein can by up to ±10%.

9. The method of claim 8, wherein the method further comprises adding an adjustment factor equal to about 12 to the first to tenth terms so that positive risk scores are associated with a greater risk of HF.

10. The method of claim 1, wherein the method further comprises determining a probability of HF for the individual by comparing the HF risk score with a distribution of HF risk scores.

11. The method of claim 1, wherein the method further comprises determining a probability of 7 day mortality for the individual according to exp(Y)/(1+exp(Y)), where Y is a log odds score of 7 day mortality.

12. The method of claim 11, wherein the method further comprises determining Y based on the received information for the individual by multiplying age in years by 0.0335293833 to form a first term; multiplying SBP in mmHg by −0.020998711 to form a second term with an upper bound of SBP of 160 mmHg for SBP measurements greater than 160 mmHg; multiplying HR in beats/min by 0.0143214613 to form a third term with lower and upper bounds of 80 bpm and 120 bpm for the individual's HR if their HR measurement is outside of that range; multiplying O₂ sat in % by −0.029957152 to form a fourth term and limiting the fourth term to −0.029957152*92 for O₂ sat greater than 92%; multiplying creatinine in mg/dL by 0.299500172 if measured in mg/dL or by 0.003388011 if measured in pmol/L to form a fifth term; setting a sixth term to 1.0443208989 if the individual was transported by an EMS vehicle or otherwise setting the sixth term to 0; setting a seventh term to 0.5345942581 if potassium concentration is greater than or equal to 4.6 mmol/L or setting the seventh term to +0.0891085889 if potassium concentration is less than or equal to 3.9 mmol/L or setting the seventh term to 0 if potassium concentration is between 4 and 4.5 mmol/L; setting an eighth term to 1.0129186121 if troponin is greater than ULN or otherwise setting the eighth term to 0; setting a ninth term to 0.7443598966 if an indication of cancer is present or otherwise setting the ninth term to 0; setting a tenth term to 0.9764137093 if the individual is currently prescribed metolazone; and adding the first to tenth terms, wherein coefficients, values and limits recited herein can by up to ±10%.

13. The method of claim 12, wherein an adjustment factor of about −3.976117131 is added to the sum of the first to tenth terms.

14. The method of claim 1, wherein the method comprises applying the HF risk score to individuals admitted at an emergency department of a hospital and storing the determined risk scores to build a database to determine a threshold for the HF risk score to delineate between individuals at high risk and low risk of HF.

15. A computer readable medium having instructions stored thereon that are operable when executed by a processor for performing a method of determining a Heart Failure (HF) risk score for an individual with a risk of acute heart failure, wherein the method comprises:
receiving demographic information;
receiving transportation information;
receiving vital signs information;
receiving blood test information;
receiving pre-existing co-morbid information;
receiving medication information; and
determining the HF risk score by employing a risk score model that employs the received information as values for corresponding variables in the risk score model.

16. An electronic device for determining a Heart Failure (HF) risk score for an individual with a risk of acute heart, failure, wherein the electronic device comprises:
at least one interface configured to receive and transmit information about the individual; and
a processor configured to control the operation of the electronic device and communicate with the at least one interface, wherein the processor is configured to receive age information, transportation information, vital signs information; blood test information, pre-existing co-morbid information, and medication information for the individual and wherein the processor is further configured to determine the HF risk score by employing a risk score model that employs the received information as values for corresponding variables in the risk score model.

17. The electronic device of claim 16, wherein the demographic information comprises an age of the individual, the transportation information comprises an indication of whether an EMS vehicle delivered the individual to a medical facility for evaluation, the vital signs information comprises systolic blood pressure (SBP), heart rate (HR) and oxygen saturation level (O₂ sat) for the individual, the blood test information comprises troponin detectability, creatinine level and potassium level for the individual, the pre-existing co-morbid information comprises an indication of whether the individual has cancer, and the medication information comprises an indication of whether the individual is currently prescribed metolazone.

18. The electronic device of claim 16, wherein, based on the received information for the individual, the processor is configured to determine the HF risk score by: multiplying age in years by 2 to form a first term; multiplying SBP in mmHg by −1 to form a second term with a an upper bound of 160 mmHg for SBP; setting HR in beats/min to a third term with a lower bound of 80 if HR is less than 80 bpm and an upper bound of 120 if HR is greater than 120; multiplying O₂ sat in % by −2 to form a fourth term and limiting the fourth term to −2*92 for O₂ sat greater than 92%; multiplying creatinine in mg/dL by 20 to form a fifth term; setting a sixth term to 60 if the individual was transported by an EMS vehicle or otherwise setting the sixth term to 0; setting a seventh term to 30 if potassium concentration is greater than or equal to 4.6 mmol/L or setting the seventh term to 5 if potassium concentration is less than or equal to 3.9 mmol/L or setting the seventh term to 0 if potassium concentration is between 4 and 4.5 mmol/L; setting an eighth term to 60 if troponin is greater than ULN or otherwise setting the eighth term to 0; setting a ninth term to 45 if an indication of cancer is present or otherwise setting the ninth term to 0; setting a tenth term to 60 if the individual is currently prescribed metolazone; and adding the first to tenth terms, wherein coefficients, values and limits recited herein can by up to ±10%.

19. The electronic device of claim 18, wherein the processor is further configured to add an adjustment factor equal to about 12 to the first to tenth terms so that positive risk scores are associated with a greater risk of HF.

20. The electronic device of claim 16, wherein the processor is further configured to determine a probability of HF for the individual by comparing the HF risk score with a distribution of HF risk scores.

21. The electronic device of claim 16, wherein the processor is further configured to determine a probability of 7 day mortality for the individual according to exp(Y)/(1+exp(Y)), where Y is a log odds score of 7 day mortality.

22. The electronic device of claim 21, wherein the processor is further configured to determine Y based on the received information for the individual by multiplying age in years by 0.0335293833 to form a first term; multiplying SBP in mmHg by −0.020998711 to form a second term with an upper bound of SBP of 160 mmHg for SBP measurements greater than 160 mmHg; multiplying HR in beats/min by 0.0143214613 to form a third term with lower and upper bounds of 80 bpm and 120 bpm for the individual's HR if their HR measurement is outside of that range; multiplying O₂ sat in % by −0.029957152 to form a fourth term and limiting the fourth term to −0.029957152*92 for O₂ sat greater than 92%; multiplying creatinine in mg/dL by 0.299500172 if measured in mg/dL or by 0.003388011 if measured in pmol/L to form a fifth term; setting a sixth term to 1.0443208989 if the individual was transported by an EMS vehicle or otherwise setting the sixth term to 0; setting a seventh term to 0.5345942581 if potassium concentration is greater than or equal to 4.6 mmol/L or setting the seventh term to +0.0891085889 if potassium concentration is less than or equal to 3.9 mmol/L or setting the seventh term to 0 if potassium concentration is between 4 and 4.5 mmol/L; setting an eighth term to 1.0129186121 if troponin is greater than ULN or otherwise setting the eighth term to 0; setting a ninth term to 0.7443598966 if an indication of cancer is present or otherwise setting the ninth term to 0; setting a tenth term to 0.9764137093 if the individual is currently prescribed metolazone; and adding the first to tenth terms, wherein coefficients, values and limits recited herein can by up to ±10%.

23. The electronic device of claim 22, wherein an adjustment factor of about −3.976117131 is added to the sum of the first to tenth terms.

24. The electronic device of claim 16, wherein the electronic device is one of a desktop computer, a laptop, a mobile device, a smart phone, a cell phone, a tablet, a personal digital assistant, a dedicated hardware device, an IT system of a medical institution, an Emergency Department Electronic Medical Records system and an Emergency Department Triage system.

25. The electronic device of claim 16, wherein the electronic device is a web server that is configured to provide a webpage for determining at least one of the HF risk score and 7 day probability of mortality.

26. The electronic device of claim 16, wherein the electronic device is a web server and the information required for the individual is sent to the web server in an electronic communication, the web server being configured to determine at least one of the HF risk score and the probability of 7 day mortality and then send this information to a predefined destination.
